(19) United States
(12) Patent Application Publication
(10) Pub. No.: US 2025/0237015 A1
(43) Pub. Date: Jul. 24, 2025

(54) ADDITIVES AND COMPOSITIONS FOR PAPERMAKING

(71) Applicant: SOLENIS TECHNOLOGIES, L.P., Wilmington, DE (US)

(72) Inventor: Daniel M. Henn, Wilmington, DE (US)

(73) Assignee: SOLENIS TECHNOLOGIES, L.P., Wilmington, DE (US)

(21) Appl. No.: 19/023,807

(22) Filed: Jan. 16, 2025

Related U.S. Application Data
(60) Provisional application No. 63/623,258, filed on Jan. 20, 2024.

(51) Int. Cl. D21H 17/37; C08F 20/56; D21H 21/18

(52) U.S. Cl. CPC D21H 17/375; C08F 20/56; D21H 21/18; C08F 2810/00

(57) ABSTRACT

A cationic polyacrylamide (cPAM) and methods of making and using the same are disclosed. The cPAM comprises the radical polymerization reaction product of an acrylamide (AM) monomer, a cationic monomer, and, optionally, one or more additional ethylenically unsaturated monomer(s). A glyoxalated polyacrylamide (gPAM) resin is also disclosed, and comprises the reaction product of a glyoxalation agent and the cationic polyacrylamide (cPAM). A homopolymer of the cationic monomer is also disclosed. An additive composition for papermaking is also disclosed, along with methods of preparing and using the same. The additive composition comprises an aqueous media and the glyoxalated polyacrylamide (gPAM) resin, or the homopolymer, dispersed therein.

### CROSS-REFERENCE TO RELATED APPLICATION

This application claims the benefit of U.S. Provisional Application No. 63/623,258, filed Jan. 20, 2024.

### FIELD OF THE DISCLOSURE

The present disclosure relates generally to compounds and compositions for papermaking and, more specifically, to cationic polyacrylamide (cPAM) and glyoxalated polyacrylamide (gPAM) resins, and cationic homopolymers, methods of making the same, and additive compositions prepared therefrom.

### BACKGROUND

Papermaking is a complex process in which paper is prepared from pulp (e.g. wood), water, filler, and various chemicals. Paper manufacturing is among the most water intensive industries, as the processes include numerous stages reliant on substantial amounts of water and aqueous solutions being added to the cellulosic fibers (i.e., the “inflow stream”) to give a furnish, and eventually separated from the furnish (i.e., the “effluent stream”) to give the final product. In the course of a typical papermaking process, a relatively concentrated aqueous slurry of cellulosic material (i.e., “thick stock”) is diluted by addition of water to give a relatively diluted slurry of cellulosic material (i.e., “thin stock”), which is used to prepare a paper web that must be dewatered to give the final product. Throughout the papermaking process, various chemical additives are employed to improve particular properties of the process (i.e., “process aids”) and/or the final product being prepared (i.e., “functional aids”). Examples of processes aids include defoamers and antifoams, retention aids, biocides, drainage aids, formation aids, etc. Examples of functional additives include strength aids, e.g. for imparting temporary wet-strength (TWS), wet-strength (WS), and/or dry-strength (DS) to the final product. In general, the working composition comprising the

In view of the number and complexity of required stages in a given papermaking process, and the number and amounts of additives utilized in each stage, there is increasing demand for additives that provide both process and functional improvements to a given processes. Unfortunately, however, achieving some sought after improvements may lead to a decrease in other performance factors. For example, achieving high retention, which can lead to improvements in the strength of the final product, can lead to reduced drainage and formation. Using conventional high molecular weight drainage aids can dive excellent drainage and retention, but offer little to no strength benefits, and in some instances even result in a reduced strength due to over-flocculation. Certain DS aids like polyamidoepichlorohydrins (PAE) can give excellent dry strength, but offer little to no drainage benefits and have limited repulpability. Complicating matters further, the efficiency of any given solution is strongly furnish dependent, with some of the best known dry strength and/or drainage aids failing under desired conditions, e.g. due to fines content, lignin content, and/or conductivity of the furnish system. As such, while there are programs to address these furnish derived performance reductions, there is a still present need for additives that provide exceptional dewatering and good dry strength in even the most challenging furnish systems.

One category of chemicals being increasingly explored for multi-use additive application includes glyoxalated polyacrylamide (gPAM) resins, which have been utilized in the paper industry for many years as processes aids, e.g. for improving water drainage during the papermaking process, and also as functional additives, e.g. for imparting temporary wet-strength (TWS), wet-strength (WS), and dry-strength (DS) to the final paper(s) being prepared. Typical gPAM resins are prepared by glyoxalating polyacrylamides (PAM), i.e., by reacting glyoxal with a PAM or PAM copolymer, such as those prepared from acrylamide (AM) and a limited pool of anionic or cationic monomers. As one example, diallyldimethylammonium chloride (DADMAC) is a cationic monomer utilized to prepare poly(AM/DADMAC) copolymers, which may be used as a prepolymer in a glyoxalation reaction to give the corresponding gPAM resins (i.e., glyoxalated poly(AM/DADMAC)). DADMAC is prominently used due to its low toxicity, wide availability, and favorable cost. However, DADMAC is not an optimal choice for the cationic monomer in most systems, as it is typically challenging to co-polymerize with acrylic monomers, and prepares resins that exhibit an inverse relationship between DADMAC content and strength performance. Furthermore, in the context of gPAMS specifically, the resulting functionality imparted by the DADMAC monomer is unable to react with glyoxal, limiting the potential theoretical amount of bound glyoxal in targeted gPAM resins. Moreover, increasing drainage performance is traditionally accomplished by increasing the amount of DADMAC in the gPAM, which both increases cost and reduces the strength performance of the resulting compositions.

Other strength and drainage additives include polyvinylamines (PVAm) and combinations, or “fusion”, of PVAm and anionic polyacrylamides. Such PVAms typically have higher treatment costs compared to gPAMs, and cannot be applied at high dosages (when used alone) due their high cationic charge. Additionally, while PVAms are associated with indirect strength benefits via formation improvements, they are not associated with significant direct strength performance. Other strength additives are also utilized, such as amphoteric PAMs (AmPAMs). However, these additives also suffer from numerous drawbacks. For example, AmPAMs are associated with poor drainage performance, and typically require the use of a cationic cofactor such as alum.

### BRIEF SUMMARY

A cationic polyacrylamide (cPAM) is provided. The cPAM comprises the radical polymerization reaction product of an acrylamide (AM) monomer, a cationic monomer, and, optionally, one or more additional ethylenically unsaturated monomer(s). Methods of making and using the cPAM are also provided.

A glyoxalated polyacrylamide (gPAM) resin is further provided, and comprises the reaction product of a glyoxalation agent and the cationic polyacrylamide (cPAM).

A homopolymer prepared from a cationic monomer is also provided.

An additive composition for papermaking is also provided, and includes the glyoxalated polyacrylamide (gPAM) resin or the homopolymer dispersed in an aqueous media. A process of forming a cellulosic article (e.g. paper) is also provided, and includes:
(1) providing an aqueous suspension of cellulosic fibers;
(2) combining an additive composition comprising a glyoxalated polyacrylamide (gPAM) resin prepared in-situ with the aqueous suspension,
(3) forming the cellulosic fibers into a sheet; and
(4) drying the sheet to produce a paper.

### DETAILED DESCRIPTION

The following detailed description is merely exemplary in nature and is not intended to limit the instant composition or method. Furthermore, there is no intention to be bound by any theory presented in the preceding background or the following detailed description. Conventional techniques related to the compositions, methods, processes, and portions thereof set forth in the embodiments herein may not be described in detail for the sake of brevity. Various tasks and process steps described herein may be incorporated into a more comprehensive procedure or process having additional steps or functionality not described in detail herein for being well-known and readily appreciated by those of skill in the art. As such, in the interest of brevity, such conventional steps may only be mentioned briefly or will be omitted entirely without providing well-known process details.

An additive composition for papermaking is provided, along with a method of preparing the additive composition, and a process for using the same. The additive composition is useful in providing a functionalized polymer to paper production processes, thereby providing process and/or product improvements based on the properties of the functionalized polymer. The functionalized polymer is selected from a cationic polyacrylamide (cPAM) and/or a glyoxalated polyacrylamide (gPAM) resin prepared therefrom, which are both also provided herein. As such, the additive composition is exemplified by an aqueous compositions comprising such cPAM and/or gPAM.

As set forth herein, the cPAM has unique functionality and provides new approaches for strength and drainage performance in papermaking, as well as new functional handles for preparing gPAM resins with both excellent drainage and excellent strength performance. More specifically, the structure/functionality of the cPAM allows for decoupled tuning of strength and drainage performance of the resulting gPAM resins, by facilitating increased cationic monomer content without the detriments to strength performance or “dead-weight” associated with conventional cationic monomer-based resins. These features represent a significant departure from and improvement over traditional DADMAC-based cPAMS and the gPAM resins prepared therefrom.

As introduced above the cPAM, as well as methods of making and using the same, are provided herein. The cPAM is generally prepared by reacting together (i.e., copolymerizing) a cationic monomer, an acrylamide (AM) monomer, and optionally one or more additional ethylenically unsaturated monomer(s) (collectively, the “monomers” or “monomer components”). The cPAM includes ionic repeat units, including at least cationic repeat units derived from the cationic monomer. Other ionic repeat units, such as cationic repeat units derived from cationic comonomers may also be utilized.

In some embodiments, the monomer components are polymerized in the presence of a chain transfer agent. The features of the cPAM will be understood in view of the components (i.e., monomers) and methods below.

The cationic monomer is generally selected from quaternary ammonium alkylation products of an allylic precursor, such as an aminoalkylacrylamide or aminoalkylacrylate precursor, or a diallylamine precursor. Such products (i.e., cationic monomers) are exemplified by N,N-dimethyl-N-2-acetamido-N-propylacryamide ammonium chloride (DMCA), e.g. prepared via alkylation of the nucleophilic tertiary amine group of dimethylaminopropylacrylamide (DIMAPA) with 2-chloroacetamide, as illustrated in the scheme below:

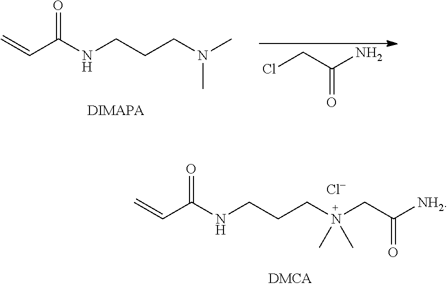

Further examples include diallylacetamidylamine (DAAA), e.g. prepared via double alkylation of the nucleophilic secondary amine group of diallyl amine:

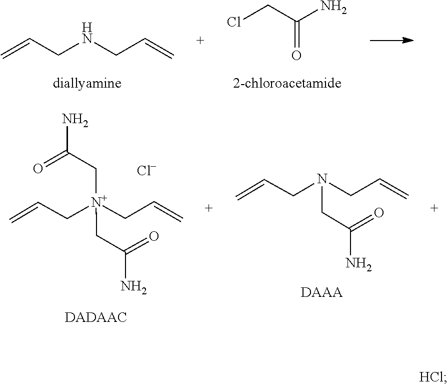

and diallylmethylacetamidylammonium chloride (DAMAAC) e.g. prepared via alkylation of the nucleophilic tertiary amine group of diallylmethyl amine:

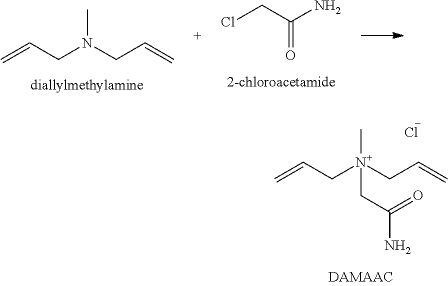

Regarding the first example above, it is to be appreciated that the aminoalkylacrylamide or aminoalkylacrylate precursor is not limited to DIMAPA specifically. Rather, other N,N-dialkylaminoalkylacrylamides and N,N-dialkylaminoalkylacrylates may also be employed, including those with different amine-bonded alkyl groups (e.g. diethylamino, dipropylamino, etc., with consideration of the need for the amine group to be readily alkylatable), different linking groups between the acrylamide/acrylate and the amino groups (e.g. ethyl, methyl, propyl, etc.), as well as different acrylamide/acrylate groups (e.g. acrylamido, methacrylamido, acrylate, methacrylate, etc.). For illustration, examples of other such aminoalkylacrylamide and aminoalkylacrylate precursors include dimethylaminopropylmethacrylamide (DIMAPMA), dimethylaminoethylmethacrylate (DMAEMA), and the like. Those of skill in the art will readily understand that other aminoalkylacrylamide and aminoalkylacrylate compounds will likewise be suitable for use as the precursor for preparing the cationic monomer.

In the same fashion, it will be appreciated that the scope of the allylic precursors are also not limited to the diallyl and diallylmethyl amine shown above, but instead may include other allylic and diallylic amino compounds, and mixtures thereof. For example, other diallylalkyl amines will be readily envisioned for use as the precursor in the same way, such as those having short to medium length N-bonded alkyl groups (e.g. ethyl, propyl, butyl, etc.).

Likewise, the cationic monomer is not limited to DMCA or other acetamido-based derivatives of DIMAPA specifically, nor to DAAA, DADAAC, DAMAAC, or other such derivatives of the diallyl precursors specifically. Rather, it is to be understood that other functionalized products are readily accessible and suitable as the cationic monomer according to the same alkylation principles illustrated by these specific examples. Said differently, functionalized quaternary ammonium derivatives of aminoalkylacrylamide and aminoalkylacrylate precursors suitable for use as the cationic monomer may be prepared via reaction of any suitable aminoalkylacrylamide or aminoalkylacrylate compound (e.g. N,N-dialkylaminoalkylacrylamides) with an electrophilic alkylation agent (e.g. X—R—Y) bearing a functional group (Y) tolerant to the reaction conditions. The alkylation of one particular such N,N-dialkylaminoalkylacrylamide (i.e., DIMAPA) with such an alkylation agent is illustrated by the scheme below:

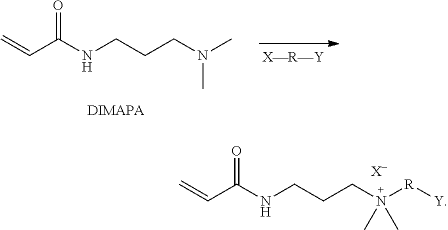

In order to facilitate the alkylation of the tertiary amino group of, X typically represents a leaving group, e.g. a group or atom that is relatively stable in the anionic form, or otherwise rendered stable under the reaction conditions (e.g. via protonation, coordination with a Lewis acid, etc.). X also renders the group X—R polar, with an attached carbon (e.g. of group R) being relatively electropositive and thus electrophilic and covalently-linkable with the nucleophilic amine of DIMAPA (i.e., in an alkylation reaction). In this sense, it will be understood that X in the alkylation agent is exemplified by chlorine, such as in the case of 2-chloroacetamide illustrated above, which provides the chloride counter anion (Cl⁻) in the cationic monomer product (i.e., DMCA). X is not limited to chlorine however, and may be selected from other halogens (e.g. Br, I, etc.), as well as organic sulfonates (e.g. tosylates, mesylates, triflates, etc.), nitrates, phosphates, and the like. That said, X will be selected based on the particular cPAM being prepared and the reaction conditions utilized, and in view of the desired gPAM and planned use thereof. More specifically, suitable choices for X will be dictated by the level of purity required by the cPAM and eventual gPAM products, the tolerance of the reactions selected, etc. Accordingly, X will be selected based on the both the suitability in the alkylation reaction to prepare the cationic monomer, but also in certain instances (e.g. where X⁻ is not removed from the cationic monomer) based on the potential presence of X⁻ in downstream products and compositions prepared from the cationic monomer. In specific embodiments, X is selected from halogens Cl, Br, and I (i.e., such that X⁻ is a corresponding halide Cl⁻, Br⁻, and/or I⁻).

The group R of the alkylation agent (e.g. X—R—Y) is not particularly limited, but is typically an organic group selected from hydrocarbons that are substituted or unsubstituted (i.e., aside from group Y). Typically, R comprises at least one methylene group (CH₂) bonded to X, to facilitate the alkylation reaction without unnecessary steric hindrance. For example, in the case of preparing cationic monomer DMCA, the alkylation agent is 2-chloroacetamide, i.e., where X is Cl, R is CH₂, and Y is an amide (—C(O)NH₂). In this sense, the alkylation agent may comprise the formula X—CH₂-D-Y, where D is a divalent linking group. Such alkylation agents may be envisioned by 3-chloropropionamide, where i.e., where X is Cl, R is CH₂, D is CH₂, and Y is an amide (—C(O)NH₂). However, it will be appreciated that R and D may comprise additional methylene groups beyond the 2-3 exemplified, such as 1, 4, 5, 6, or even more methylene groups. In this sense, X and Y may be separated by but 1 carbon atom, or instead by 2, 3, 4, 5, 6, or more carbon atoms (i.e., where R is a divalent hydrocarbyl linking group having from 1-6 carbon atoms).

The functional group Y is not particularly limited, beyond the requirements of the reactions being utilized in the preparation of the cationic monomer, as well as the cPAM being prepared therefrom. Typically, however, Y is selected from hydrogen bonding groups (i.e., donors and/or acceptors), groups reactive under glyoxalation conditions (e.g. when preparing the gPAM from the cPAM), and/or groups that can be later functionalized or otherwise rendered reactive (e.g. anhydrides, esters, etc.). For example, aside from the amides exemplified above, Y may be selected from amines, esters, anhydrides, carboxylic acids, hydroxyl, sulfates, amides, sulfamides, imides, aldehydes, etc. In some such embodiments, Y is selected from amides, amines, and hydroxyl. In particular embodiments, Y is an amide. In all cases, the functional group Y is present on the alkylation agent, which may thus be referred to or otherwise described as a functionalized alkylation agent. In specific embodiments, the cationic monomer is prepared substantially free from alkylation products of the aminoalkylacrylamide or aminoalkylacrylate precursor from non-nucleophilic alkylation agents. In such embodiments, Y comprises at least one nucleophilic group (e.g. an amide, amine, or hydroxyl), and the alkylation reaction does not employ non-nucleophilic alkylation agents (e.g. chloromethane).

In general, the cationic monomer of the present embodiments is typically selected for an ability to give repeat units in a polymerization product (i.e., the cPAM described herein) that participate inter-fiber bonding via both donating and accepting hydrogen bonds, as well as for reactivity to glyoxal, thus alleviating the dead-weight of conventional cationic monomers while also increasing the potential strength performance. These principles will inform those of skill in the art as to the overall scope of the cationic monomer being used, the compounds suitable for preparing the cationic monomer, as well as the nature of the cPAM being prepared.

It will be appreciated by those of skill in the art that, as with any chemical reaction (e.g. organic synthesis), the intended product (i.e., the cationic monomer) is typically made along with various side products and/or impurities, such as residual starting materials (e.g. from incomplete reaction), products of side reactions, mixtures of equilibrium-based products, etc. In some embodiments, the resulting product of the alkylation reaction, i.e., the reaction product comprising the cationic monomer, is used directly without a discrete purification step. In some embodiments, the method comprises a purification step, i.e., where the alkylation reaction product is subjected to purification to isolate, purify, and/or obtain the cationic monomer in a purified state. The purification may be formed using techniques known in the art, such as chromatography, precipitation, trituration, filtration, crystallization, distillation, lyophilization, extractions, washings, and the like, as well as combinations (e.g. sequential purifications) involving any two or more of such techniques. Any purification may also be performed more than once, e.g. to incrementally purify or otherwise obtain the cationic monomer.

In some embodiments, the alkylation reaction gives a reaction product comprising the cationic monomer as well as a 1,4-conjugate addition product (i.e., Michael adduct), which is understood in the art as the product of a reaction of a nucleophile (i.e., Michael donor) and an α,β-unsaturated carbonyl (i.e., Michael acceptor) such as an acrylic group- or, more particularly with respect the cationic monomer described above, an acrylamido group. As will be understood by the description of the alkylation reaction components herein, the particular 1,4-conjugate addition product present in the alkylation reaction product with the cationic monomer will be controlled by the particular components selected and utilized in the reaction.

In some embodiments, preparing the cationic monomer comprises altering (e.g. raising) the pH of the reaction product as a purification step. For example, in some such embodiments, the pH of the alkylation reaction product is raised to facilitate a base-promoted retro-Michael reaction from the 1,4-conjugate addition product (i.e., effectively reversing the 1,4-conjugate addition), thereby reducing the amount of the 1,4-conjugate addition product present with the cationic monomer. It will be appreciated that such a pH modification may be performed during and/or after the alkylation reaction (i.e., as part of a continuous process, or alternatively as a discreet step), depending on the particulars of the reaction being performed. Additional and/or alternative techniques, such as selectively controlling the temperature of the reaction mixture (e.g. during alkylation, during pH modification, etc.) in order to facilitate a favorable reaction dynamic when equilibrium-based reaction products are being produced. Typically, the alkylation is carried out to reduce the presence of all products aside from the cationic monomer. In some embodiments, however, the reaction conditions may be selected to favor one or more particular side products (i.e. in additional to the cationic monomer), such as a side product that is more easily removed from the reaction mixture or is less detrimental to the further reaction steps described herein.

In certain embodiments, the cationic monomer is prepared as an alkylation reaction product comprising a 1,4-conjugate addition side product (i.e., a Michael adduct) as described above. In such embodiments, the 1,4-conjugate addition side product may be present in an amount at the low-end of from greater than 0 (i.e., any amount detectible by known quantification techniques). In these embodiments, the 1,4-conjugate addition side product may be present in any amount at the high-end as long as the cationic monomer is also present. For example, in some embodiments, the cationic monomer is prepared as an alkylation reaction product comprising the 1,4-conjugate addition side product in an amount of from greater than 0 to less than about 10 wt. %, such as from greater than 0 to less than about 9, alternatively less than about 8, alternatively less than about 7, alternatively less than about 6, alternatively less than about 5, alternatively less than about 4, alternatively less than about 3 wt. %, based on the total weight of the cationic monomer.

In some such embodiments, the alkylation reaction product comprises the 1,4-conjugate addition side product in an amount of from greater than 0 to less than about 2, alternatively less than about 1, alternatively less than about 0.1 wt. %, based on the total weight of the cationic monomer. In typical embodiments, the total amount of the 1,4-conjugate addition side product is minimized to the extent possible, while also allowing for such side product formation to occur and reduce other impurities in the final product. For example, in some such embodiments the alkylation reaction product is prepared to comprise no more than about 10 wt. % of the 1,4-conjugate addition side product, based on the total weight of the reaction product. In specific embodiments, the cationic monomer is prepared as the alkylation reaction product comprising the 1,4-conjugate addition side product in an amount of from about 5 to about 10 wt. %, based on the total weight of the cationic monomer, and used without further purification. In other embodiments, the cationic monomer is prepared substantially free from the 1,4-conjugate addition side product, or is otherwise purified to give the cationic monomer in a form that is substantially free from the 1,4-conjugate addition side product. Such purification techniques may include the pH and/or temperature modification steps described above.

The cPAM may include one or more cationic comonomers, which may be any additional type of cationic monomer (i.e., a monomer that comprises cationic functionality and is different from the cationic monomer described above) that is capable of reacting with the cationic monomer, the AM monomer, and/or other monomers/comonomers to form the cPAM (e.g. via radical chain polymerization).

Examples of cationic comonomers that may be used in addition to the cationic monomer include tertiary and quaternary diallyl amino derivatives, or tertiary and quaternary amino derivatives of acrylic acid or (meth)acrylic acid or acrylamide or (meth)acrylamide, vinylpyridines and quaternary vinylpyridines, or para-styrene derivatives containing tertiary or quaternary aminoderivatives. Cationic comonomers may be chosen from diallyldimethylammonium chloride (DADMAC), (3-acrylamidopropyl)trimethylammonium chloride (APTAC), (3-methacrylamidopropyl)trimethyl ammonium chloride, (2-acrylamidoethyl)trimethylammonium chloride, (2-methacrylamidoethyl)trimethylammonium chloride, N-methyl-2-vinylpyridinium N-methyl-4-vinylpyridinium, p-vinylphenyltrimethylammonium chloride, p-vinylbenzyltrimethylammonium chloride, (2-acryloyloxyethyl)trimethylammonium chloride, (2-methacryloyloxyethyl)trimethylammonium chloride, (3-acryloyloxypropyl)trimethyl ammonium chloride, (3-methacryloyloxypropyl)trimethylammonium chloride, and the like, as well as combinations thereof. It is understood that mixtures of cationic comonomers can be used to the same purpose. In some embodiments, the cPAM is prepared with a cationic comonomer comprising diallyldimethylammonium chloride (DADMAC).

Notwithstanding the above, in some embodiments the cPAM is substantially free from, alternatively is free from, other cationic repeat units aside from those derived from the cationic monomer (i.e., the cPAM is prepared without the use of any cationic comonomer). It is known that typical cPAM and gPAM retention aids require cationic repeat units, such as those from DADMAC, to promote retention to anionically charged cellulosic fibers. As such, addition of more DADMAC to conventional copolymers becomes a tradeoff between dewatering efficiency and strength performance characteristics of the additive, with higher cationically charged materials being associated with improved drainage. Additionally, promotion of bonding between cellulosic fibers to improve the dry strength of paper or board by addition of natural or synthetic additives such as gPAM is widely known to be related to increasing hydrogen bonding between fibers. However, as conventional cationic monomer (e.g. DADMAC) content can be causally linked to decreased strength performance, and thus any such content of cationic comonomer in the present embodiments (i.e., conventional cationic monomers used in addition to the specific cationic monomer described above) can be viewed as increasing dead-weight in the polymer, as the resulting cationic units from such comonomers do nothing to improve bonding between cellulosic fibers. Accordingly, in some embodiments the cPAM is prepared without any cationic comonomer, i.e., the cPAM is substantially free from any cationic repeat units different from those provided by the cationic monomer described above.

In specific embodiments, the cPAM is free from non-nucleophilic cationic repeat units. For example, in some such embodiments the cPAM is free from DADMAC-based units (i.e., where no DADMAC is used to prepare the cPAM), APTAC-based units (i.e., where no DADMAC is used to prepare the cPAM), or both.

The cPAM may contain other monomer units provided by the selection and use of one or more additional ethylenically unsaturated monomer(s) in the polymerization. Such additional monomers are typically selected to not significantly interfere with the formation (polymerization) of the cPAM itself, as well as to not significantly interfere with the glyoxalation process used to prepare gPAM resins from the cPAM. For example, additional monomer units can be selected from acrylates and alkyl acrylates (e.g. methacrylates, methyl methacrylate, etc.), styrenes, vinyl acetates, and/or alkyl acrylates.

It will be appreciated by those of skill in the art that incidental comonomers may also be present during the formation of the cPAM, such as ethylenically unsaturated compounds prepared as side products in the formation of one of the desired monomer/comonomers selected for use in preparing the cPAM. For example, when the cationic monomer is prepared as the alkylation reaction product comprising an amount of the 1,4-conjugate addition side product described above, that side product may be incorporated into the cPAM during polymerization. Likewise, residual starting material carried over after the alkylation reaction of the cationic monomer may also be incorporated into the cPAM, such as when the cationic monomer is prepared as the alkylation reaction product, that product contains residual starting material, and that product is used without purification or removal of such starting material. As such, it is to be understood that other ethylenically unsaturated compounds carried over with any monomer used to prepare the cPAM can act as additional monomers incorporated into the cPAM, thereby adding additional functionality thereto. Typically, the incorporation of such other monomers into the polymerization is intentionally limited, and incidental incorporation of nominal amounts of these other monomers (i.e., as impurities/byproducts/carry-over materials) may be ignored or otherwise not considered when describing the final cPAM, which is typically done based on the actual monomers selected for use and incorporated therein.

A method of preparing the cPAM is also provided. However, it is to be understood that multiple processes to prepare cPAM and related polymers are known in the art, and thus the method may be adapted from conventional methods of preparing cPAM prepolymers suitable for glyoxalation to give a gPAM resin. Examples include free radical polymerization in water, such as via use of a redox initiating system (e.g. sodium metabisulfite and sodium persulfate). Other combinations of redox initiating systems for initiating polymerization of suitable comonomers may also be used, including other persulfate salts such as potassium persulfate or ammonium persulfate or other components such as potassium bromate. Such redox initiating systems may be used in combination with a chain transfer agent, such as a sodium hypophosphite, sodium formate, isopropanol, or mercapto compound-based chain transfer agent. Likewise, thermal initiators may also be employed. Such thermal initiators are known in the art, and may be utilized in any suitable fashion known for initiating polymerization of the monomers described herein.

Typically, preparing the cPAM comprises radical polymerization of all monomers. Polymerization is typically carried out in an aqueous solution (e.g. in aqueous media). The polymerization may be carried out at any suitable temperature, such as at about room temperature, at a reduced temperature (e.g. below room temperature), or at an elevated temperature (e.g. at a temperature of at least about 50° C.). It is sometimes advantageous to raise the temperature after the addition of all comonomers has been completed so as to reduce the level of residual monomers in the product. It will be understood that multiple temperatures may thus be utilized. For example, an initiation temperature at or below room temperature may be employed, optionally along with a final polymerization temperature of at least about 50° C. to increase monomer incorporation. Those of skill in the art will appreciate the typical temperatures utilized at the different reaction stages, which will be independently or collectively selected to provide the particular cPAM desired. Likewise, it will be appreciated that the pH of the polymerization reaction may also be adjusted (e.g. with acids or bases, or with a buffer), and with suitable pH ranges typically being dependent on the initiator system and components used in the reaction.

Comonomers maybe added all at once or added over any length of time. If one monomer is less reactive than another, then it is advantageous to add part or all of the slower reacting monomer at the start of the polymerization, followed by a slow continuous or multiple batch wise additions of more reactive monomer. Adjusting feed rates can lead to more uniformity of the compositions of polymer chains. Likewise, initiators may be added at once or added over any length of time. To reduce the amount of residual monomer in the copolymer, is often advantageous to continue adding the initiator system for some time after all monomers have been added, or to introduce batch wise additional amounts of initiator. Controlling polymer compositional and molecular weight uniformity by controlling addition times is well known in the polymer industry.

As described and exemplified in the embodiments above, the cPAM is typically prepared using the cationic monomer. More specifically, the cationic monomer is typically formed (e.g. via the alkylation reaction), and then subsequently polymerized with all other monomers to form the cPAM. It is to be understood however, that the non-alkylated aminoalkylacrylamide or aminoalkylacrylate precursor (e.g. DIMAPA) used to form the cationic monomer may be used directly to prepare a PAM prepolymer (e.g. comprising nucleophilic tertiary amine groups), which may then be alkylated to prepare the cPAM. Such a process will be understood by those of skill in the art in view of the embodiments set forth herein without departing from the scope thereof. As such, while described in terms of the cationic monomer used (i.e., in the alkylated state), the cPAM is to be expressly understood to be achievable via pre-polymerization or post-polymerization alkylation of the neutral amine groups of the aminoalkylacrylamide or aminoalkylacrylate precursor.

In some embodiments, the cPAM is prepared with at least one predetermined physical property, such as cationic monomer content, reduced solution viscosity (RSV), charge density, and/or zeta potential.

Any method known in the art can be used to control molecular weight of the cPAM by changing polymerization conditions, such as via modifying and/or selecting particular ranges for the concentration of monomers, the concentration of initiators, and the concentration of chain transfer agents. Similarly, the level of oxygen in the reaction mixture can be varied, although oxygen may also be purged from the reaction mixture.

The cPAM may be prepared in a wide-range of molecular weights, such as a weight-average molecular weight (Mw) of from about 5 to about 500 kDa (e.g. via size-exclusion chromatography (SEC)). Particular values outside this Mw range may also be achieved (e.g. from about 1 to about 5 kDa, of greater than 500 kDa, etc.). Likewise, depending on a desired use of the cPAM, ranges overlapping or encompassed within the above range may be achieved. The particular Mw dispersity of the cPAM may thus be selected by those of skill in the art in view of the description herein based on the intended use of the cPAM, and controlled using known methods and techniques compatible with the present embodiments. Likewise, particular Mw values may be utilized on the basis of another targeted property, such as reduced specific viscosity (RSV). In particular embodiments, for example, the cPAM is prepared with a Mw of from about 50 to about 250 kDA, such as from about 100 to about 175, alternatively from about 105 to about 160 kDa, each with a RSV of from about 0.90 to about 1.2, alternatively from about 0.95 to about 1.16. Such particular embodiments are described for exemplary purposes, as it will be readily understood that the cPAM may comprise different Mw and/or RSV values.

The cationic monument content of the cPAM is not particularly limited. For example, the cPAM typically comprises from about 1 to 98 mol % of cationic monomer units derived from the cationic monomer. In some embodiments, the cPAM comprises from about 1 to about 50, alternatively from about 1 to about 30, alternatively from about 2 to about 30, alternatively from about 2 to about 25, alternatively from about 2 to about 20, alternatively from about 2 to about 15, alternatively from about 2 to about 12, alternatively from about 3 to about 10 mol % of repeat units derived from the cationic monomer. However, it is to be understood that amounts outside these ranges may also be utilized.

In various embodiments, the cPAM comprises a total amount of cationic repeat units (i.e., from the cationic monomer and any cationic comonomer utilized) of at least about 1 mol %, such as at least about 2, alternatively at least about 3, alternatively at least about 4, alternatively at least about 5, alternatively at least about 6, alternatively at least about 10, alternatively at least about 15, alternatively at least about 10, alternatively at least about 25 mol %.

When utilized, the cationic comonomers may be employed in any amount. For example, the cationic comonomer (CC) may be utilized in a ratio with the cationic monomer (CM) (e.g. to save costs, alter the properties of the resulting polymer, etc. In these cases, a ratio of from about 100:0 to about 1:99, alternatively from about 99:1 to about 1:99 (CM:CC) may be employed.

In these or other embodiments, the cPAM typically has a RSV of from about 0.2 to about 1.8 dL/g, such as from about 0.6 to about 1.6 dL/g, alternatively from about 0.8 to about 1.4, alternatively from about 0.9 to about 1.3, alternatively from about 0.95 to about 1.2 dL/g.

In these or other embodiments, the cPAM typically has a zeta potential of from about 1 to about 30 mV, at pH 7. In some embodiments, the cPAM has a zeta potential of from about 5 to about 30 mV, such as from about 15 to about 30, alternatively from about 20 to about 30, alternatively from about 20 to about 25 mV, at pH 7.

In these or other embodiments, the cPAM typically has a charge density of from about 0.2 to about 3 mEq./g, such as from about 1 to about 3, mEq./g, at pH 7.

In some embodiments, a crosslinker may be utilized during or after the polymerization of the cPAM. For example, N,N-dimethylacrylamide (DMA), methylene bis-acrylamide (MBA), diallylamines, triallylamines, tetraallylamines, or the like, may be added to the reaction as crosslinking agents, as demonstrated in the examples below. It will be appreciated that other crosslinking agents may also be used, and generally include monomers that comprise at least two functional groups capable of crosslinking the cPAM. Additional examples of these crosslinking agents include the di- and trifunctional comonomers described above (e.g. DADMAC, etc.). Such crosslinking agents, as well as variations, modifications, and derivatives thereof, are known in the art and may be employed in the present embodiments. It will be appreciated the combinations of such crosslinking agents may also be utilized.

As introduced above, the gPAM resin is prepared by glyoxalating the cPAM, that is, reacting the cPAM with glyoxal or a suitable derivative to prepare a gPAM resin therefrom. As such, a method of preparing the gPAM resin is provided, and includes glyoxalating the cPAM (e.g. as prepolymer) to give a gPAM therefrom. The method may be used to selectively glyoxalate the cPAM by controlling the concentration of cPAM in an aqueous media during glyoxalation. In this fashion, gPAM resins having high Mw can be prepared, optionally decoupled from the Mw of the cPAM utilized as the prepolymer being glyoxalated.

Preparing the gPAM resin comprises glyoxalating the cPAM, i.e., reacting the gPAM with glyoxal, glyoxylic acid, or a similar functionalization agent, to give the gPAM resin. As understood in the art, the reaction the cPAM with glyoxal may be carried out under varied conditions of time, temperature, pH, etc. Typically, the glyoxal is added quickly to the cPAM to minimize crosslinking. Alternatively, the cPAM can be added to the glyoxal. It is also generally understood in the art that the molecular weight of the cPAM, and the ratio of glyoxal to acrylamide groups on the cPAM (including any of those from the cationic monomer), may be adjusted to achieve desired levels of crosslinking and viscosity build during a glyoxalation process

The cPAM and the glyoxal are typically reacted in a dry weight (w/w) ratio of from about 75:25 to about 95:5, such as from about 80:20 to about 90:10.

It is typically preferred to run the glyoxalation reaction at a higher concentration (i.e., % solids) of the cPAM to optimize the efficient use of the reaction vessel and/or to obtain a final product of with a higher gPAM concentration. However, the particular conditions will be selected in order to control the properties of the gPAM (e.g. MW, Rg, etc.) and/or gPAM composition (e.g. viscosity, etc.), which will include the degree of intermolecular crosslinking, as described herein.

In some embodiments, the glyoxalation reaction specifically comprises monitoring and selectively controlling the solids content of the reaction, in terms of the gPAM product. In other words, in such embodiments the progress of the reaction may be monitored, and the amount of gPAM being prepared may be controlled. In this fashion, the glyoxalation may be carried out as a “low-solids” process or a “high-solids” process, e.g. depending on the desired use and/or application of the gPAM being prepared. For example, when carrying out the glyoxalation reaction on-site, as described in further detail below, the glyoxalation is typically performed as a low-solids process. When the glyoxalation is carried out off-site, e.g. prior to subsequent storage and/or shipment, a high-solids process may be favored (e.g. to reduce the economics of storage, transport, etc.) . . . . In general, those of skill in the art will understand a “low-solids” process to be, in the context of the glyoxalation, any process where a significant viscosity build is not observed (i.e, a low-solids process can run practically indefinitely and not gel). In contrast, a “high-solids” process in this same context is a process where a significant viscosity build is observed and, if not quenched, will eventually reach a gel point. Therefore, it is to be appreciated that the cut off between high-solids and low-solids processes becomes dynamic and related to the identity and characteristics of the reaction components (e.g. cPAM Mw, ratio of cPAM to glyoxal, etc.). The solids value at which a process moves between a high and low solids process may be understood as the “critical concentration” of a given reaction. Accordingly, it is to be appreciated that the glyoxalation may be carried out at a high or low solids content, on site or off site, with particular processes selected by those of skill in the art. Parameters and properties of such process variations are set forth herein, but may be modified, supplemented, and/or replaced by other glyoxalation techniques known in the art. Such processes may be selected based on a desired property of the gPAM resin (e.g. Mw, viscosity, Rg, charge density, zeta potential, etc.) and/or additive composition (e.g. solids content, viscosity, etc.) being prepared, or a particular use thereof.

The monitoring of the reaction progression is not limited to any particular technique, but instead may be carried out using any known method applicable with the reaction conditions selected. For example, the reaction may be monitored according to a property directly related to the solids content of the gPAM prepared, such as the turbidity, viscosity, pH, and/or temperature of the reaction. Likewise, the reaction may be monitored according to a property indirectly related to the solids content, i.e., a property useful for monitoring the glyoxalation reaction, such as via current consumption of a circulation pump, stirrer, etc. influenced by the reaction viscosity. It is generally known that the reaction mixture will increase in viscosity as the gPAM is being prepared. Any of such properties may be monitored over time, e.g. as a difference measurement, and multiple properties may be monitored in tandem for precise value determination and control.

The concentration of the cPAM can be selectively controlled to alter the Mw of gPAM resin prepared. For example, in some embodiments, the cPAM is present in the aqueous media at an initial concentration of from about 0.9 to about 5.7%, alternatively from about 1.5 to about 2.3%. This concentration is typically defined in terms of solids, i.e., the weight percent concentration of the starting cPAM at the start of the glyoxalation reaction, that is when all of the glyoxal has been added. In general, these ranges are implemented for a low-solids process, as introduced above. In such embodiments, the gPAM resin may be prepared in the aqueous media at a solids content (%) of about A+B, where A is the initial concentration of the cPAM in the aqueous media utilized in the glyoxalation, and B is a conversion factor based on one or more of the predetermined physical properties of the cPAM or a parameter of the glyoxalation reaction itself. In this fashion, the solids content of the cPAM and the solids content of the gPAM resin may be described in view of each other. Likewise, selective glyoxalation may be understood to include selecting a desired cPAM concentration based on a desired gPAM resin solids content in the additive composition.

In some embodiments, the glyoxalation process utilized generates a high level of reactive aldehyde functionality on the final gPAM resin without creating too many intermolecular crosslinks or excessively building up the gPAM molecular weight and/or the viscosity of the final aqueous gPAM resin composition prepared. It is known that intermolecular crosslinks tend to cause the viscosity to quickly rise, in some instances causing gelling to occur, and reduce final product stability (i.e., shelf life). At the same time, intermolecular crosslinks may be desired to build a higher molecular weight of the final gPAM resin as also described herein. Accordingly, the present embodiments may be used to obtain a balance between a high-reactivity of the final polymer, the weight percent of gPAM resin in the resulting aqueous composition, the level of residual/unreacted glyoxal in that gPAM composition, and the ageing stability of the final gPAM product prepared. One of skill in the art will appreciate that a high reactivity of the final gPAM can lead to higher wet strengths of paper made with the additive compositions of the present embodiments, and some embodiments the level of wet-strength decay may also be controlled.

The gPAM resins may be adjusted to a pH of about 3 after glyoxalation to improve storage stability until they are used, or may be used directly without further adjustment.

The residual level of glyoxal of the final gPAM resin is typically below about 10%, alternatively below about 8%, alternatively below about 5%, on a dry weight basis of the gPAM resin. However, other amounts outside (e.g. below) these values may also be achieved by altering the reaction parameters and/or utilizing post-polymerization processing.

In some instance, the process may include removing excess glyoxal at the end of the reaction or from the final product. Methods well known in the chemical arts can be used, such as membrane filtration. The residual level of glyoxal after removal of excess glyoxal and/or pH adjustment is typically less than about 15 wt. %, on the basis of the gPAM resin. In some embodiments, the residual glyoxal content is less than about 12, alternatively less than about 10, alternatively less than about 8, alternatively less than about 6, alternatively less than about 5, alternatively less than about 2, alternatively less than about 1 wt. %, on the basis of the gPAM resin. In specific embodiments, after removal of excess glyoxal and pH adjustment of the aqueous gPAM composition, the residual glyoxal content therein is less than 1 wt. % of the total weight solids of the gPAM composition. In such embodiments, the residual glyoxal content may be controlled to an amount less than about 0.8, alternatively less than about 0.5, alternatively less than about 0.2, alternatively less than about 0.1% of the final the gPAM composition by weight.

The solids of the final gPAM resin in the additive composition is typically from about 2 to 25%, from about 5 to 20%, or from about 7 to 15%, or from about 8 to 13% weight percent. However, amounts outside these ranges may also be targeted, as will be understood by those of skill in the art. In general, the aforementioned ranges are typical of a high-solids process used in the glyoxalation, whereas the solids of the final gPAM resin in the additive composition prepared using the low-solids process will be in line with the ranges set forth further above, e.g. from about 0.9 to about 5.7%, alternatively from about 1.5 to about 2.3%. The overlap in such ranges will be understood by those of skill in the art in view of the description of the critical concentration above.

The gPAM resin typically has a Mw of at least about 3 megadaltons (MDa). In certain embodiments, the gPAM resin has a Mw of at least about 3.5 MDa, alternatively at least about 4, alternatively at least about 5, alternatively at least about 8, alternatively at least about 10 MDa. The range of Mw is not particularly limited above the bottom values of these ranges noted (i.e., about 3 MDa or above, alternatively about 3.5 MDa or above, etc.). As such, the gPAM resin may have a Mw in the range of from 3 to 50 MDa, such as from 5 to 50, alternatively from 5 to 45, alternatively from 10 to 40 MDa. In specific embodiments, the gPAM resin may have a Mw higher than those listed in the aforementioned ranges. Such gPAM resins may be achieved and provide the benefits of the additive composition disclosed herein. The particular Mw can be selected by one of skill in the art in view of the embodiments shown and described herein, e.g. in view of a desired use or particular application of the additive composition being targeted.

The gPAM resin typically has a radius of gyration (Rg) of at least about 100 nm, and may exhibit a Rg up to about 230 nm in certain embodiments. In some embodiments, the gPAM resin has a Rg of at least about 120 nm, such as at least about 130, alternatively at least about 140, alternatively at least about 150, alternatively at least about 190, alternatively at least about 200, alternatively at least about 220 nm. In specific embodiments, the gPAM resin may have a Rg higher than those listed in the aforementioned ranges.

The gPAM resin typically has a charge density of from about 0.2 to about 3 mEq./g, at pH 7. In some embodiments, the gPAM resin has a charge density of from about 1 to about 3, mEq./g, at pH 7. In specific embodiments, the gPAM resin may have a charge density outside the aforementioned ranges.

The gPAM resin typically has a zeta potential of from about 1 to about 30 mV, at pH 7. In some embodiments, the gPAM resin has a zeta potential of from about 2 to about 30 mV, such as from about 5 to about 30, alternatively from about 5 to about 25, alternatively from about 5 to about 20, alternatively from about 5 to about 15 mV, at pH 7. In specific embodiments, the gPAM resin may have a zeta potential outside the aforementioned ranges.

The particular properties and features of the gPAM resin, including those introduced above, will be appreciated in view of the method and components utilized in the preparation method set forth herein.

The additive composition comprises the gPAM resin and the aqueous media. The aqueous media is not particularly limited, and may comprise, alternatively may be, any aqueous composition compatible with the gPAM resin and/or the components used to prepare the same. In this fashion, the aqueous media may be a water-based solution or suspension, optionally including additional components, such as process water from a papermaking operation, or simply an aqueous carrier vehicle used in the preparation of the gPAM resin.

Typically, the additive composition comprises the gPAM resin in the aqueous media in functional amount, i.e., in a solids content that maximizes the amount of gPAM resin while maintaining a useful flowable state of the composition. In this sense, the gPAM resin may be present in the additive composition in an amount of from greater than 0 wt. % to less than the gel point of the gPAM resin in the aqueous media. In some embodiments, the gPAM resin is present in an amount of from about 1.2 to about 6%, such as from about 1.2 to about 5, alternatively from about 1.3 to about 4, alternatively from about 1.4 to about 3, alternatively from about 1.95 to about 2.45% based on the aqueous media (i.e., as % solids). However, as will be appreciated from the method below, the amount of gPAM present in the composition may be dependent on the amount of cPAM utilized in the glyoxalation method. Furthermore, it is to be appreciated that the gPAM prepared in the glyoxalation reaction may be used as the additive composition (i.e., such that the reaction product of the glyoxalation is the additive composition). Alternatively, the additive composition may be prepared from the reaction product of the glyoxalation, e.g. via dilution, concentration, and/or adding additional components thereto. In some specific embodiments, the gPAM is prepared on-site and the additive composition comprises, alternatively is, the direct reaction product from glyoxalating the cPAM (i.e., without further processing/purification).

In general, the method of preparing the additive composition comprises preparing the gPAM resin in the aqueous media, or in another aqueous media which is formulated into the final additive composition. As such, the preparation of the gPAM resin described in detail herein may be used in addition to or in place of conventional processes known in the art.

In certain embodiments, the additive composition comprises, alternatively is, the aqueous gPAM resin composition obtained directly from the glyoxalation method set forth herein. In this fashion, as described in additional detail herein, the glyoxalation may be performed in advance of a desired time of use of the additive composition (i.e., “off-site”), or instead may be carried out at substantially the same time the additive composition is to be utilized (i.e., “on-site”). The time between formation of the gPAM resin, the reactive window thereof, the gPAM content in the additive composition, and other factors known in the art, will all be utilized to inform the practical limits on the concentration of a particular gPAM resin in the additive composition of the present embodiments.

The additive composition may be used to make paper, which comprises pulp and the gPAM resin. The additive composition used in paper making may lead to beneficial properties, such as, e.g. improved dry strength, temporary wet-strength, permanent wet-strength, wet-strength decay, etc., compared to the same properties when a conventional gPAM resin (i.e., free from repeat units derived from the cationic monomer described herein) is used.

In the paper making process there are multiple steps, generally including: forming an aqueous suspension of cellulosic fibers; addition of additives (e.g. the additive composition) to the suspension; forming a sheet from the fibers; and drying the sheet to give the paper. Additional steps may also be employed. For example, for tissue and towel grades, a forth step of creping or forming a structure of the paper to provide properties such as softness is typically employed. These steps and variations of the process are known to those skilled in the art.

In view of the above, a process of forming paper is also provided herein. The process generally comprises:
(1) providing an aqueous suspension of cellulosic fibers;
(2) combining the additive composition with the aqueous suspension;
(3) forming the cellulosic fibers into a sheet; and
(4) drying the sheet to produce a paper.

The additive composition is typically prepared and subsequently combined with a pre-formed aqueous suspension of cellulosic fibers. As introduced above, the time between preparing and using the additive composition may vary. For example, the gPAM resin may be prepared and introduced to the suspension within a time period suitable for storage, such as within about 10, alternatively of about 8, alternatively of about 5 hours after glyoxalation.

As introduced above, the additive composition may be prepared as an aqueous suspension immediately prior to being utilized, i.e., where the gPAM resin is prepared in-situ as an aqueous suspension and immediately (or soon after) combined with the aqueous suspension of cellulosic fibers. Such processes are known in the art as “on-site” processes, and are particularly suitable for use in the present embodiments with the cPAM prepolymer and final gPAM resin described herein. That said, it will be appreciated that, depending on the solids content of the additive composition, there no particular limits as the to the storage life, and thus “off site” preparation may also be utilized.

As introduced above, the paper making process may further comprise additional steps involving drying, patterning, treating, and/or creping the paper to form a finished paper product. Finished paper products are exemplified by tissue (e.g. bath, facial, etc.), towel, paperboard, etc., which can be consumer grade, commercial grade, etc., and made from any combination of virgin and/or recycled fiber.

A DMCA homopolymer and method of preparing the same, as well as an additive composition and use of the same, are further provided herein. As will be understood by those of skill in the art in view of the description above and the examples below, the DMCA homopolymer is prepared using the techniques and reagents described above, and may be used in place of the cPAM prepolymer as described herein. The DMCA homopolymer may also be used as an additive, e.g. in place of the gPAM resin described herein.

### EXAMPLES

The following examples, illustrating embodiments of this disclosure, are intended to illustrate and not to limit the invention. Unless otherwise noted, all solvents, substrates, and reagents are purchased or otherwise obtained from various commercial suppliers (e.g. Sigma-Aldrich, VWR, Alfa Aesar) and utilized as received (i.e., without further purification) or as in a form used conventionally in the art.

### Determination of Polymer Properties

The cPAM prepolymer RSV is determined at 0.25 wt. % in 1 M ammonium chloride using a Poly Visc.

The cPAM Mw is determined using relative SEC against known standards.

The GPAM Mw is determined by batch MALS, or AF4 MALS.

### Method of Batch Mode MALS Analysis

Instrument: Wyatt DAWN HELEOS (18-angle light scattering detector) with flow to batch kit. The instrument was calibrated using toluene for calibration and a narrow PEG standard ˜130K was used for normalization.

Sample Prep: The GPAM sample as received was dissolved in the mobile phase in a dust free glass vial and tumble for one hour at RT and then transferred in a scratch and dust free scintillation vial that was carefully prepared before the batch mode MALS experiment. The sample solution was analyzed without filtration. The batch mode MALS data was processed using Astra 7 software.

### Conditions:

Mobile Phase: 0.2M LiNO3//0.5 M acetic acid filtered through 0.22 μm filter
Sample Concentration: 0.2 mg/mL
dn/dc: 0.167 ml/g

### Method of AF4-MALS Analysis

A PostNova asymmetrical flow field flow fractionation (AF4) system was used to perform the AF4-MALS experiment. The system was calibrated using bovine serum albumin standard and all the 21 angles in the light scattering detector were normalized using a 64K narrow polystyrene sulfonate standard before the sample analysis. The GPAM sample as received was dissolved in the mobile phase in a dust free glass vial and tumble for one hour at RT. The sample solution was then transferred to a 2 mL autosampler vial and analyzed without filtration using AF4-MALS.

### AF4 Conditions:

Mobile Phase: 0.2M LiNO3/0.5M acetic acid filtered through 0.22 μm filter
Concentration: 5 mg/mL
Injection Volume: 40 μL
dn/dc: 0.167 ml/g
Membrane: 10K PES
Spacer: 350 μm
AF4 Method:

| | |
|---|---|
| [symbol] | [symbol] |
| [symbol] | [symbol] |
| [symbol] | 350 μm |

| | |
|---|---|
| Focusing | |
| [symbol] | [symbol] |
| [symbol] | [symbol] |
| [symbol] | [symbol] |
| [symbol] | [symbol] |

| [symbol] | [symbol] | [symbol] | [symbol] | Type | [symbol] |
|---|---|---|---|---|---|
| 1 | [symbol] | [symbol] | [symbol] | [symbol] | |
| 2 | [symbol] | [symbol] | [symbol] | [symbol] | [symbol] |
| 3 | [symbol] | [symbol] | [symbol] | [symbol] | |
| 4 | [symbol] | [symbol] | [symbol] | [symbol] | [symbol] |
| 5 | [symbol] | [symbol] | [symbol] | [symbol] | |
| 6 | [symbol] | [symbol] | [symbol] | [symbol] | |

| | |
|---|---|
| [symbol] | |
| [symbol] | [symbol] |
| [symbol] | [symbol] |
| [symbol] | [symbol] |
| [symbol] | [symbol] |
| [symbol] | |

[symbol]

indicates data missing or illegible when filed

### Cationic Monomer Synthesis: N,N-Dimethyl-N-2-Acetamido-N-Propylacrylamide Ammonium Chloride (DMCA)

Water (482.09 g), 2-chloroacetamide (175.03 g), and methyl hydroquinone (0.29 g) are combined in a round bottomed flask fitted with an over head stirrer and pH meter. The flask is heated to 60° C. to dissolve the chloroacetamide. Once the mixture is at temperature and all the chloroacetamide has dissolved, a 5% NaOH solution is added drop wise to raise the pH to 8. Once at a pH of 8, dimethylaminopropyl acrylamide (DIMAPA) (307.06 g) is added over 120 minutes at 2.55 g/min. After the addition of DIMAPA is complete, the reaction is held at temperature for 120 minutes. The reaction is then cooled to 25° C. and the pH is lowered to 6.5 by addition of 5% H₂SO₄. The final reaction mixture as determined by LC/MS and NMR contains water (51%), DMCA (40%), a Michael adduct of DIMAPA and DMCA (7%), DIMAPA (0.6%), and carboxylic acid hydrolysis product of DMCA (0.5%), acrylic acid (0.3%) and chloroacetamide (0.1%), the remainder being made of trace impurities and inorganic salts. The final reaction mixture can be used without further purification.

| Monomer | Mass % actives basis | Mol % actives basis |
|---|---|---|
| DMCA | 80 | 85 |
| DIMAPA-DMCA | 18 | 12 |
| adduct | | |
| DIMAPA | 2 | 3 |

### Cationic Monomer Synthesis: Diallylacetamidylamine (DAAA):

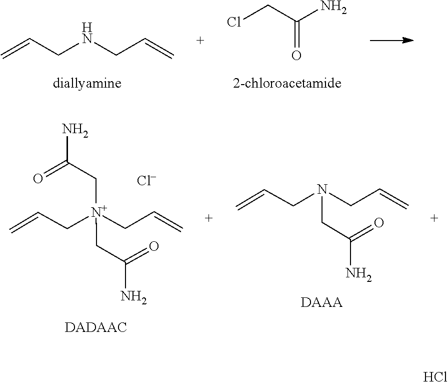

A reaction flask is charged with 2-chloroacetamide and DI water. The mixture is heated to 55° C. The reaction flask, two external feeds are connected, one containing diallylamine, and the other containing a sodium hydroxide solution. The diallylamine feed is delivered over 2 h. The sodium hydroxide feed is started 40 min after the start of the diallylamine feed and delivered over 5 h. The reaction is held at 55° C. for an additional 2 h. The reaction is then cooled to room temperature, and pH is adjusted to 4 with hydrochloric acid. 1H NMR analysis indicated that the product mixture was 74% DAAA, 24% unreacted diallylamine, and 1-2% diallyldiacetamidyl ammonium chloride (DADAAC) on an actives molar basis.

| Monomer | Mol % actives basis |
|---|---|
| Diallylacetamidylamine (DAAA) | 74 |
| Diallylamine (DA) | 24 |
| Diallyldiacetamidylammonium | ~1-2 |
| chloride (DADAAC) | |

Cationic Monomer Synthesis: Diallylmethylacetamidyl ammonium chloride (DAMAAC):

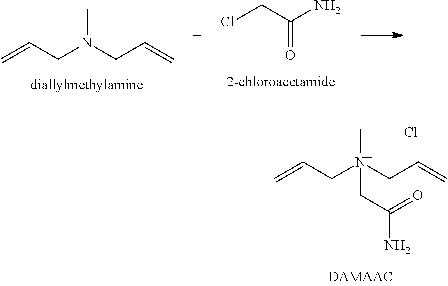

A reaction flask is charged with 2-chloroacetamide, optionally zinc (II) chloride as a catalyst, and DI water. The mixture is heated to 55° C. An external feed of diallylmethylamine was delivered over 1 h. After the conclusion of the feed, the temperature is increased to 75° C. for an held for an additional 6 h. The reaction is cooled to room temperature and the pH is adjusted to 3 with hydrochloric acid. 1H NMR analysis indicated that the product mixture was 76% DAMAAC and 24% unreacted diallylmethylamine on an actives molar basis.

| Monomer | Mol % actives basis |
|---|---|
| Diallylmethylacetamidylammonium | 76 |
| chloride (DAMAAC) | |
| Diallylmethylamine (DAMA) | 24 |

Synthesis of Cationic Monomer 1-propanaminium, N-(2-amino-2-oxoethyl)-N,N-dimethyl-3-[(1-oxo-2-propen-1-yl)amino]-, chloride (DMCA) with low Michael adduct

In order to reduce the amount of the Michael adduct, after cooling to 25° C. the pH is raised to 11 with 10% NaOH and held via as necessary dropwise addition of NaOH for 1 hour. The pH is then reduced to 6.5 with 10% H₂SO₄. The final reaction composition is, approximately: water (60%), DMCA (35%), Michael adduct of DIMAPA and DMCA (3%), DIMAPA (1%), acrylic acid (0.25%), chloroacetamide (0.09%), with the remainder being made up of trace impurities.

General Cationic Polyacrylamide (cPAM) Synthesis Procedure 1

A reaction flask is charged with DI water, a pH modifier, a chelating agent, and a chain transfer agent. To the reaction flask three external feeds are connected, one containing acrylamide, another containing DMCA, and the other containing sodium metabisulfite (SMBS) and chain transfer reagent. Optionally, the acrylamide and DMCA can be mixed and fed together. The mixture in the reactor is bubbled with nitrogen for 30 min at room temperature, then ammonium persulfate (APS) and sodium bromate are added, followed by starting the external feeds. The acrylamide and DMCA feeds are added over 135 minutes, the SMBS feed is added over 145 minutes. During the acrylamide and DMCA feeds, the reaction is gradually heated through an external heating source at ˜0.5° C./min up to 90° C. After the conclusion of the acrylamide and DMCA feeds, a second portion of APS is added, and the reaction is held at 90° C. for one hour. The amount of DMCA is varied as necessary to make a prepolymer with the desired amount of cationic monomer. The molecular weight of the cPAM prepolymer is manipulated by increasing or reducing the amount of chain transfer agent as necessary.

Preparation of Crosslinked cPAM using N,N-dimethylacrylamide (DMA)

A reaction flask was charged with DI water (121.03 g), adipic acid (0.26 g, pH modifier), sodium hypophosphite (3.75 g of 1.5% solution, chain transfer agent), and Trilon C (0.44 g of 40% solution, chelant). The reaction flask contents where sparged with nitrogen for 30 minutes and heated to 70° C. A monomer mixture containing acrylamide (113.61 g of 50% solution), DMCA (45.61 g of 40% solution), N,N-dimethylacrylamide (1.20 g), and sodium hypophosphite (3.78 g of 1.5% solution) was prepared separately. A 5% ammonium persulfate solution (13.54 g) was prepared separately. The monomer mixture and ammonium persulfate solution where feed into the reaction flask simultaneously over a period of 60 minutes. After the completion of the feeds, the reaction temperature was increased to 90° C. and a second 5% ammonium persulfate solution (4.06 g) was added over a period of 5 minutes. The reaction was held at 90° C. for 55 minutes before being stopped by cooling and opening to air. The RSV of the resulting cPAM was 1.07 dL/g.

Preparation of gPAM Using DMA-Crosslinked cPAM

The cPAM prepared in the procedure above was glyoxalated at 1.7% with a cPAM: glyoxal mass ratio of 85:15 at pH 10 for 20 minutes. GPAM Brookfield viscosity was 12 cPs, Mw was 4.097 MDa, Rg was 133 nm.

Preparation of Crosslinked cPAM Using N,N′-Methylenebisacrylamide (MBA)

A reaction flask was charged with DI water (123.11 g), adipic acid (0.30 g), sodium hypophosphite (4.43 g of 1.5% solution), and Trilon C (0.54 g of 40% solution). The reaction flask contents where sparged with nitrogen for 30 minutes and heated to 70 C. A first monomer mixture containing acrylamide (62.69 g of 50% solution), DMCA (24.23 g of 40% solution), N,N′-methylenebisacrylamide (1.89 g of 2% solution), and sodium hypophosphite (2.11 g of 1.5% solution) was prepared separately. A second monomer mixture containing acrylamide (79.33 g of 50% solution), DMCA (2.91 g of 40% solution), N,N′-methylenebisacrylamide (2.21 g of 2% solution), and sodium hypophosphite (2.47 g of 1.5% solution) was prepared separately. A 5% ammonium persulfate solution was prepared separately. The first monomer mixture and ammonium persulfate solution (7.35 g) where feed into the reaction flask simultaneously over a period of 25 minutes. After the completion of the first feeds, the second monomer mixture and ammonium persulfate solution (8.62 g) were subsequently feed into the reaction flask over a period of 25 minutes. The reaction temperature was increased to 90° C. and a third 5% ammonium persulfate solution (4.79 g) was added over a period of 5 minutes. The reaction was held at 90° C. for 55 minutes before being stopped by cooling and opening to air. The RSV of the resulting cPAM was 1.09 dL/g.

Preparation of gPAM Using MBA-Crosslinked cPAM

The cPAM was glyoxalated at 1.5% with a cPAM: glyoxal mass ratio of 85:15 at pH 10.1 for 7.5 minutes. GPAM Brookfield viscosity was 23 cPs.

General Glyoxalated Polyacrylamide (gPAM) Synthesis Procedure (Glyoxalation)

A cPAM prepolymer is charged to a reaction flask and diluted with DI water so the concentration of the polymer is as desired, to which is added glyoxal at 15:85 dry w: w ratio relative to the cPAM prepolymer. The pH is increased to 10.2 using dilute NaOH and this pH is maintained for the desired reaction time. After which, the reaction is quenched by reducing the pH to 4 with dilute sulfuric acid.

Preparation & Performance Examples: cPAM and gPAM Resins

Various cPAM and gPAM resins are prepared and analyzed according to the Glyoxalation procedure above. Specific parameters and properties of the cPAM and gPAM resins are set forth in the tables below.

### Handsheet Preparation:

OCC was refined in a cycle beater as received until the CSF was between 350 mL-400 mL. Handsheets were produced using a noble and wood handsheet mold. The quantity of pulp necessary to form ten 100 lb/3000 sqft sheets is added to the porportioner and diluted to 10 L using conditioned water (pH 7, 2000 uS/cm). The strength additives (GPAMs, unless otherwise specified) are added at the listed dosage followed by a commercial cPAM retention aid at 0.25 lb/ton, with about 30 seconds between each addition. A sheet is made by dewatering the required amount of treated pulp using a forming wire and deckle box, then pressing the sheet (60 PSI), and finally drying the sheet on a drum dryer (245° F.). A total of eight sheets are made for each condition. Each condition was repeated in at least duplicate, resulting in 16 total sheets per condition.

### Pilot Paper Machine Prep:

A furnish made up of AOCC fibers was dispersed in water adjusted to a pH of 7 and this dispersed fiber is treated with additives at any or all of the points described as the thick stock pump inlet and outlets, wet end approach system in order from mixer 1 to 4, thin stock fan pump inlet, outlet, and dilution. The GPAM was applied at mixer 3, and commercial retention aid was added at the fan pump outlet. The stock was applied to the paper machine through a flow spreader (hydraulic) head box onto a fourdrinier equipped with three vacuum assisted baffles to remove water forming a wet sheet. The wet sheet was then passed through two single felt presses to mechanically remove water and densify the sheet. The final water removal (drying) is carried out using eleven electrically heated dryer cans before being wound up onto a core at the reel, targeting a basis weight of 100 lb/3000 sqft.

Water used was conditioned with calcium chloride (147 g per 1000 L), sodium bicarbonate (84 g per 1000 L), and sodium sulfate was used to adjust conductivity to 2000 uS/cm.

### Mechanical Strength Performance of the Paper

Ring crush was measured with a Testing Machines Inc. Model 17-76-00-0001 using TAPPI method T 822 om-16. STFI was measured with a Buchel BV Short Span Compression Tester Model 17-34-00-0001 using TAPPI method T 826 om-21. Mullen Burst was measured with B. F. Perkins Model C Mullen Tester according to standard TAPPI method T 807 om-16. For the pilot paper machine, the machine direction performance of the STFI and cross directional performance of ring crush were tested and reported. All strength performance data were normalized to basis weight and are reported relative to the performance of a blank sample, which was treated with all additives except for the gPAM.

### Dynamic Drainage Analysis.

American old corrugated container (AOCC) was refined to a CSF of ˜400 mL and then diluted with DI water to a consistency of 0.9%. To the diluted pulp was added calcium chloride (147 g per 1000 L), sodium bicarbonate (84 g per 1000 L), sodium sulfate (added until the solution conductivity reached ˜2000 μS/cm). The pH of the pulp was adjusted to 7 using concentrated sulfuric acid, followed by the addition of 2.5 wt % of oxidized starch (GPC D-28F). Drainage time was measured using a Dynamic Drainage Analyzer 4 instrument from PulpEye. A 60-mesh screen with a 95 mm cross-sectional filtration diameter was used. The analyzer applies a 300 mbar vacuum and measures the time between application of vacuum and the vacuum break point, or when air breaks through the thickening fiber mat. To perform the test, 750 mL of furnish was charged into the sample receptacle and the pulp was stirred. After 15 seconds of stirring, the polymer additive was charged to the stirring pulp slurry, and the stirring was continued for an additional 10 seconds. The instrument then stops stirring, applies vacuum, and records the pressure vs. time.

The results of the analyses are set forth in the tables below. For the performance comparisons, the examples set forth in each table were run at the same time in the same furnish.

| | Cat. | mol % | | | | |
|---|---|---|---|---|---|---|
| | Monomer | CM | RSV | | STFI | RC |
| EXAMPLE | (CM) | (cPAM) | (cPAM) | Dose | (%) | (%) |
| Example 1 | DMCA | 8.2 | 1.07 | 6 | N/A | 13.6 |
| Comparative 1 | DADMAC | 4.1 | 0.8 | 6 | N/A | 11.3 |
| Comparative 2 | APTAC | 8.2 | 0.96 | 6 | N/A | 9.9 |

| | Cat. | mol % | | | | |
|---|---|---|---|---|---|---|
| | Monomer | CM | RSV | | STFI | RC |
| EXAMPLE | (CM) | (cPAM) | (cPAM) | Dose | (%) | (%) |
| Example 2 | DMCA | 8.2 | 1.07 | 6 | N/A | 15.3 |
| Comparative 3 | DADMAC | 4.1 | 0.8 | 6 | N/A | 14.8 |
| Comparative 4 | DADMAC | 8.2 | 0.95 | 6 | N/A | 11.8 |
| Comparative 5 | APTAC | 8.2 | 0.96 | 6 | N/A | 12.2 |

| | Cat. | mol % | | | | |
|---|---|---|---|---|---|---|
| | Monomer | CM | RSV | | STFI | RC |
| EXAMPLE | (CM) | (cPAM) | (cPAM) | Dose | (%) | (%) |
| Example 3 | DMCA | 8.2 | 1.07 | 6 | N/A | 12 |
| Example 4 | DMCA | 8.2 | 1.45 | 6 | N/A | 12.5 |
| Comparative 6 | DADMAC | 4.1 | 0.8 | 6 | N/A | 9.8 |

| | Cat. | mol % | | | | | gPAM | gPAM |
|---|---|---|---|---|---|---|---|---|
| | Monomer | CM | RSV | | STFI | RC | Mw | Rg |
| EXAMPLE | (CM) | (cPAM) | (cPAM) | Dose | (%) | (%) | (MDa) | (nm) |
| Example 5 | DMCA | 4.1 | 1.1 | 6 | 10.5 | 9 | 33.98 | 222 |
| Example 6 | DMCA | 6.2 | 1.16 | 6 | 11.7 | 16.3 | 23.41 | 228 |
| Example 7 | DMCA | 8.2 | 1.17 | 6 | 12 | 14.8 | 14.99 | 174 |
| Comparative 7 | DADMAC | 4.1 | 0.8 | 6 | 7.2 | 8.8 | 5.219 | 105 |

| | Cat. | mol % | | | | | | gPAM | gPAM |
|---|---|---|---|---|---|---|---|---|---|
| | Monomer | CM | RSV | | STFI | RC | Mullen | Mw | Rg |
| EXAMPLE | (CM) | (cPAM) | (cPAM) | Dose | (%) | (%) | (%) | (MDa) | (nm) |
| Example 8 | DMCA | 6.2 | 0.95 | 6 | 7.9 | 9.6 | 13.1 | 11.26 | 138 |
| Example 9 | DMCA | 6.2 | 0.95 | 9 | 10.8 | 12.5 | 16.5 | 11.26 | 138 |
| Example 10 | DMCA | 6.2 | 0.95 | 12 | 14.5 | 15.5 | 15.9 | 11.26 | 138 |
| Comparative 8 | DADMAC | 4.1 | 0.8 | 6 | 3.3 | 4.4 | 7.1 | 5.219 | 105 |
| Comparative 9 | DADMAC | 4.1 | 0.8 | 9 | 9.7 | 8.8 | 12.1 | 5.219 | 105 |
| Comparative 10 | DADMAC | 4.1 | 0.8 | 12 | 12.2 | 13.8 | 10.2 | 5.219 | 105 |

| | Cat. | mol % | | | | | | gPAM | gPAM |
|---|---|---|---|---|---|---|---|---|---|
| | Monomer | CM | RSV | | STFI | RC | Mullen | Mw | Rg |
| EXAMPLE | (CM) | (cPAM) | (cPAM) | Dose | (%) | (%) | (%) | (MDa) | (nm) |
| Example 11 | DMCA | 6.2 | 1.06 | 6 | N/A | 13.6 | 14.5 | 19.1 | 186 |
| Example 12 | DIMAPA | 6.2 | 1.06 | 6 | N/A | 8.6 | 10.5 | 15.08 | 189 |
| Comparative 11 | DADMAC | 4.1 | 0.8 | 6 | N/A | 7.1 | 13.1 | 35.21 | 188 |

| | Cat. | mol % | | | |
|---|---|---|---|---|---|
| | Monomer | CM | RSV | | Drainage |
| EXAMPLE | (CM) | (cPAM) | (cPAM) | Dose | (%) |
| Example 13 | DMCA | 8.2 | 1.07 | 6 | 25.9 |
| Comparative 12 | DADMAC | 4.1 | 0.8 | 6 | 17.6 |
| Comparative 13 | DADMAC | 8.2 | 0.95 | 6 | 21.4 |
| Comparative 14 | APTAC | 8.2 | 0.96 | 6 | 17.3 |

| | Cat. | | | | | gPAM | gPAM |
|---|---|---|---|---|---|---|---|
| | Monomer | mol % CM | RSV | | Drainage | Mw | Rg |
| EXAMPLE | (CM) | (cPAM) | (cPAM) | Dose | (%) | (MDa) | (nm) |
| Example 14 | DMCA | 4.1 | 1.1 | 6 | 29.9 | 33.98 | 222 |
| Example 15 | DMCA | 6.2 | 1.16 | 6 | 33.5 | 23.41 | 228 |
| Example 16 | DMCA | 8.2 | 1.17 | 6 | 31.1 | 14.99 | 174 |
| Comparative 15 | DADMAC | 4.1 | 0.8 | 6 | 21.5 | N/A | N/A |

| | Cat. | | | | | gPAM | gPAM |
|---|---|---|---|---|---|---|---|
| | Monomer | mo1% CM | RSV | | Drainage | Mw | Rg |
| EXAMPLE | (CM) | (cPAM) | (cPAM) | Dose | (%) | (MDa) | (nm) |
| Example 17 | DMCA | 6.2 | 1.16 | 4 | 23.3 | 23.41 | 228 |
| Example 18 | DMCA | 6.2 | 1.16 | 6 | 29.1 | 23.41 | 228 |
| Example 19 | DMCA | 6.2 | 1.16 | 9 | 36.7 | 23.41 | 228 |
| Example 20 | DMCA | 6.2 | 1.16 | 12 | 39.3 | 23.41 | 228 |
| Comparative 16 | DADMAC | 4.1 | 0.8 | 4 | 16.5 | 9.71 | 141 |
| Comparative 17 | DADMAC | 4.1 | 0.8 | 6 | 16.9 | 9.71 | 141 |
| Comparative 18 | DADMAC | 4.1 | 0.8 | 9 | 20.9 | 9.71 | 141 |
| Comparative 19 | DADMAC | 4.1 | 0.8 | 12 | 21.5 | 9.71 | 141 |

Dosage (dose) units are lb/ton. (lb active polymer/ton dry paper pulp).

STFI, RC, Mullen, and Drainage values are all reports as % improvement over blank, based on the procedures set forth above.

The 8.2 mol % DADMAC, APTAC, and DMCA GPAMs were glyoxalated using the following conditions: 1.7% prepolymer, 85:15 pp: glyoxal, 25 C, pH 10, 1000s.

The 4.1% DMCA GPAM was made under similar conditions, except the reaction was stopped after 12 minutes when a viscosity increase was observed.

The 6.2% DMCA GPAM with a prepolymer RSV of 1.15 was made at 1.6% prepolymer, pH 9.8, and stopped after 25 minutes when the turbidity had increased by 4 NTU.

The 6.2% DMCA GPAM with a prepolymer RSV of 1.16 was made at 1.6% prepolymer, pH 10, 20-22 C, and stopped after 20 minutes when +4 NTU was reached.

The 6.2% DMCA GPAM with a prepolymer RSV of 0.95 was made at 1.75% pp, pH 9.8, and stopped after 20 minutes when +4 NTU was reached. The Brookfield viscosities ranged from 9-32 cPs.

In view of the above, the additive composition can be readily envisioned for use in enhancing machine productivity. Additionally, the gPAM resins therein may be used to give good dry strength.

Preparation of cPAM Resins Containing DAAA and DAMAAC

A reaction flask is charged with DI water, a pH modifier, a chelating agent, a chain transfer agent, and DAAA or DAMAAC prepared according to the Cationic Monomer Synthesis procedures above. To the reaction flask two external feeds are connected, one containing acrylamide and the other containing sodium metabisulfite (SMBS) and chain transfer reagent. The mixture in the reactor is bubbled with nitrogen for 30 min at room temperature, then ammonium persulfate (APS) and sodium bromate are added, followed by starting the external feeds. The acrylamide feed is added over 135 minutes, and the SMBS feed is added over 195 minutes. During the acrylamide feed, the reaction is gradually heated through an external heating source at ˜0.5° C./min up to 90° C. After the conclusion of the acrylamide feed, a second portion of APS is added, and the reaction is held at 90° C. for one hour. The amount of DAAA or DAMAAC is varied as necessary to make a prepolymer with the desired amount of cationic monomer. The molecular weight of the cPAM prepolymer is manipulated by increasing or reducing the amount of chain transfer agent as necessary.

Parameters of the reactions and properties of the resulting cPAM resins are set forth in the table below:

| | Cat. Monomer | | |
|---|---|---|---|
| | Mixture | mol % CMM | cPAM composition |
| Example | (CMM) | (cPAM) | (mol %) |
| 21 | DAAA | 12.8 | 9.5/3.1/0.2/87.4 |
| | | | DAAA/DA/DADAAC/ACM |
| 22 | DAAA | 12.8 | 9.5/3.1/0.2/87.4 |
| | | | DAAA/DA/DADAAC/ACM |
| 23 | DAAA | 20.6 | 15.2/4.9/0.5/79.4 |
| | | | DAAA/DA/DADAAC/ACM |
| 24 | DAAA | 4.2 | 3.1/1.0/0.1/95.8 |
| | | | DAAA/DA/DADAAC/ACM |
| 25 | DAMAAC | 12.8 | 9.7/3.1/87.4 |
| | | | DAMAAC/DAMA/ACM |

| Example: | 21 | 22 | 23 | 24 | 25 |
|---|---|---|---|---|---|
| Total solids (%) | 19 | 19 | 21 | 29.8 | 17 |
| Brookfield viscosity (cPs) | 831 | 535 | 830 | 10318 | 427 |
| RSV (dL/g) | 0.9 | 0.8 | 0.9 | 0.72 | 0.8 |
| Charge density (meq/g) at pH 4 | 1.5 | 1.5 | 2 | N/A | 1.5 |
| Charge density (meq/g) at pH 7 | 1.5 | 1.5 | 1.9 | 0.6 | 1.5 |
| Charge density (meq/g) at pH 8 | 1.2 | 1.2 | 1.5 | N/A | 1.4 |
| Charge density (meq/g) at | 0.2 | 0.1 | 0.3 | N/A | 1.3 |
| pH 10.2 | | | | | |

Preparation of gPAM Resins: Glyoxalation of DAAA and DAMAAC Containing cPAMs:

A cPAM prepolymer prepared according to General cPAM Synthesis Procedure 2 is charged to a reaction flask and diluted with DI water so the concentration of the polymer is as desired, to which is added glyoxal at 15:85 dry w: w ratio relative to the cPAM prepolymer. The pH is increased to 10.2 using dilute NaOH and this pH is maintained for the desired reaction time. After which, the reaction is quenched by reducing the pH to 4 with dilute sulfuric acid.

Various gPAM resins are prepared according to the procedure above using the cPAM resins of Examples 21-25. The gPAM resins are then characterized and assessed according to the procedures further above, with the results set forth below.

### Mechanical Strength Performance of the Paper

| | | mol % | | | | |
|---|---|---|---|---|---|---|
| Hand sheet | | CM | RSV | | STFI | RC |
| run #1 | CM | (cPAM) | (cPAM) | Dose | (%) | (%) |
| Example 22 | DAAA | 12.8 | 0.77 | 8 | 12.8 | 17.4 |
| Example 25 | DAMAAC | 12.8 | 0.81 | 8 | 13.2 | 17.3 |
| Comparative 20 | DADMAC | 12.8 | 1.1 | 8 | 10.5 | 9.3 |

| Hand sheet | | mol % CM | RSV | | STFI |
|---|---|---|---|---|---|
| run #2 | CM | (cPAM) | (cPAM) | Dose | (%) |
| Example 21 | DAAA | 12.8 | 0.91 | 6 | 12.2 |
| Example 22 | DAAA | 12.8 | 0.77 | 6 | 14.5 |
| Comparative 21 | DADMAC | 4.1 | 0.8 | 6 | 10.6 |
| Comparative 22 | DADMAC | 12.8 | 1.1 | 6 | 9 |

### Dynamic Drainage Analysis.

| | | mol % | | | |
|---|---|---|---|---|---|
| | | CM | RSV | | Drainage |
| EXAMPLE | CM | (cPAM) | (cPAM) | Dose | (%) |
| Example 22 | DAAA | 12.8 | 0.77 | 6 | 34.6 |
| Example 25 | DAMAAC | 12.8 | 0.81 | 6 | 34.6 |
| Comp. Ex. 23 | DADMAC | 12.8 | 1.1 | 6 | 36.4 |

As above, dosage (dose) units are lb/ton. (lb active polymer/ton dry paper pulp), and STFI, RC, and Drainage values are all reports as % improvement over blank. Strength and drainage performance of the DAAA and DAMAAC containing GPAMs compared to HB Plus HC:

Furnish: 100% OCC, 380 CSF, 2.5% GPC D28F, pH 7, 2000 μS/cm water conductivity adjusted with sodium sulfate, standard hardness. Hand sheets basis weight: 100 lb/3000 sq ft. Drainage measured using 750 mL furnish at 0.9% consistency, 300 mbar vacuum.

### Synthesis of DMCA Homopolymer:

A reaction flask was charged with DI water and a pH modifier. To the reaction flask two external feeds are connected, one containing DMCA, and the other containing 2,2′-azobis(2-methylpropionamidine) dihydrochloride (V-50). The mixture in the reactor is bubbled with nitrogen for 30 min at room temperature, then brought to 60° C. The external feeds are then started and feed over 135 min. After the conclusion of the feeds, the reaction temperature is increased to 90° C., and a second portion of V-50 is added. After 50 minutes, and third portion of V-50 is optionally added. Reaction is held at 90° C. for an additional 50 minutes before cooling.

A DMCA homopolymer is prepared according to the procedure above. The parameters of the reaction and properties of the resulting polymer are set forth in the table below:

| | Total | | | |
|---|---|---|---|---|
| | solids | Brookfield | RSV | Mw SEC |
| Composition (mol %) | (%) | viscosity (cPs) | (dL/g) | (kDa) |
| 80/18/12 DMCA/DIMAPA- | 21.1 | 645 | 0.94 | 276.6 |
| DMCA adduct/DIMAPA | | | | |

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It being understood that various changes may be made in the function and arrangement of elements described in an exemplary embodiment without departing from the scope as set forth in the appended claims. Moreover, all combinations of the aforementioned components, compositions, method steps, formulation steps, etc. are hereby expressly contemplated for use herein in various non-limiting embodiments even if such combinations are not expressly described in the same or similar paragraphs.

With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the ranges and subranges enumerated herein sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. An individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims. Lastly, it will be understood that the term “about” with regard to any of the particular numbers and ranges described herein is used to designate values within standard error, equivalent function, efficacy, final loading, etc., as understood by those of skill in the art with relevant conventional techniques and processes for formulation and/or utilizing compounds and compositions such as those described herein. As such, the term “about” may designate a value within 10, alternatively within 5, alternatively within 1, alternatively within 0.5, alternatively within 0.1, % of the enumerated value or range.

While the present disclosure has been described with respect to particular embodiments thereof, it is apparent that numerous other forms and modifications will be obvious to those skilled in the art. The appended claims and this disclosure generally should be construed to cover all such obvious forms and modifications, which are within the true scope of the present disclosure.

1. A cationic polyacrylamide (cPAM), comprising the radical polymerization reaction product of:
an acrylamide (AM) monomer;
a cationic monomer comprising a quaternary ammonium alkylation product of a precursor selected from aminoalkylacrylamides, aminoalkylacrylates, diallylamines, diallylalkylamines, and combinations thereof; and
optionally, one or more additional ethylenically unsaturated monomer.

2. The cationic polyacrylamide (cPAM) of claim 1, wherein the precursor is: (i) an N,N-dialkylaminoalkylacrylamide or N,N-dialkylaminoalkylacrylate, and wherein the cationic monomer is further defined as a quaternary ammonium alkylation product of the N,N-dialkylaminoalkylacrylamide or N,N-dialkylaminoalkylacrylate and an alkylation agent; or (ii) an N,N-diallylamine or N,N-diallylalkylamine, and wherein the cationic monomer is further defined as a quaternary ammonium alkylation product of the N,N-diallylamine or N,N-diallylalkylamine and an alkylation agent.

3. The cationic polyacrylamide (cPAM) of claim 2, wherein the alkylation agent is further defined as an electrophilic alkylation agent having the formula X—R—Y, where X is a leaving group, R is a substituted or unsubstituted hydrocarbon linking group, and Y is a functional group selected from amines, esters, anhydrides, carboxylic acids, hydroxyl, sulfates, amides, sulfamides, imides, and aldehydes.

4. The cationic polyacrylamide (cPAM) of claim 3, wherein X is a halogen, R is a divalent hydrocarbyl linking group having from 1 to 6 carbon atoms, and Y is selected from amides, amines, and hydroxyl.

5. The cationic polyacrylamide (cPAM) of claim 2, wherein the cationic monomer has the structural formula (I): 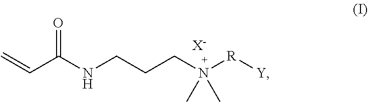
wherein R is a substituted or unsubstituted hydrocarbon group, X is a counter anion, and Y is a functional group selected from amines, esters, anhydrides, carboxylic acids, hydroxyl, sulfates, amides, sulfamides, imides, and aldehydes.

6. The cationic polyacrylamide (cPAM) of claim 1, wherein the cationic monomer comprises N,N-dimethyl-N-2-acetamido-N-propylacryamide ammonium chloride (DMCA), Diallylacetamidylamine (DAAA), Diallyldiacetamidylammonium chloride (DADAAC), Diallylmethylacetamidylammonium chloride (DAMAAC), or a combination thereof.

7. The cationic polyacrylamide (cPAM) of claim 1, wherein the cationic monomer (A2), and optionally the one or more additional ethylenically unsaturated monomer (A3) are polymerized in the presence of a chain transfer agent.

8. The cationic polyacrylamide (cPAM) of claim 1, wherein:
(i) the AM monomer comprises acrylamide;
(ii) the one or more additional ethylenically unsaturated monomer, when present, comprises a monomer selected from styrenes, alkyl acrylates, and vinyl acetates; or
(iii) both (i) and (ii).

9. The cationic polyacrylamide (cPAM) of claim 1, wherein the one or more additional ethylenically unsaturated monomer is present in the radical polymerization reaction, and wherein the one or more additional ethylenically unsaturated monomer comprises at least one: (i) cationic comonomer; (ii) multi-functional crosslinking agent; or (iii) both (i) and (ii).

10. The glyoxalated polyacrylamide (gPAM) resin of claim 9, wherein one or more additional ethylenically unsaturated monomer comprises the cationic comonomer, and wherein the cationic comonomer comprises dimethylaminopropylacrylamide (DIMAPA), diallyldimethylammonium chloride (DADMAC), (3-acrylamidopropyl)trimethylammonium chloride (APTAC), (3-methacrylamidopropyl)trimethyl ammonium chloride, (2-acrylamidoethyl)trimethylammonium chloride, (2-methacrylamidoethyl)trimethylammonium chloride, N-methyl-2-vinylpyridinium N-methyl-4-vinylpyridinium, p-vinylphenyltrimethylammonium chloride, p-vinylbenzyltrimethylammonium chloride, (2-acryloyloxyethyl)trimethylammonium chloride, (2-methacryloyloxyethyl)trimethylammonium chloride, (3-acryloyloxypropyl)trimethyl ammonium chloride, (3-methacryloyloxypropyl)trimethylammonium chloride, or a combination thereof.

11. The glyoxalated polyacrylamide (gPAM) resin of claim 9, wherein one or more additional ethylenically unsaturated monomer comprises the multi-functional crosslinking agent, and wherein the multi-functional crosslinking agent comprises N,N-dimethylacrylamide (DMA), methylene bis-acrylamide (MBA), a diallylamine, a triallylamine, a tetraallylamine, or a combination thereof.

12. The cationic polyacrylamide (cPAM) of claim 1, wherein the cPAM is substantially free from: (i) non-nucleophilic cationic repeat units; (ii) repeat units derived from diallyldimethylammonium chloride (DADMAC) and/or (3-acrylamidopropyl)trimethylammonium chloride (APTAC); or (iii) both (i) and (ii).

13. The cationic polyacrylamide (cPAM) of claim 1, wherein the cPAM further comprises a Michael adduct formed from a 1,4-conjugate addition reaction between the N,N-dialkylaminoalkylacrylamide and the alkylation agent.

14. A glyoxalated polyacrylamide (gPAM) resin, comprising the reaction product of a glyoxalation agent, alternatively glyoxal or a derivative thereof, and the cationic polyacrylamide (cPAM) of claim 1.

15. The glyoxalated polyacrylamide (gPAM) resin of claim 14, wherein the glyoxalation agent comprises glyoxal, and wherein the cPAM and the glyoxal are reacted: (i) in a dry weight (w/w) ratio of from about 70:30 to about 95:5, alternatively from about 80:20 to about 90:10; (ii) in a low-solids glyoxalation process with a solids content less than about 5%; (iii) in a high-solids glyoxalation process with a solids content of at least about 5%; or (iv) a combination of (i) and (ii) or (i) and (iii).

16. An additive composition for papermaking, comprising:
an aqueous media; and
the glyoxalated polyacrylamide (gPAM) resin of claim 14.

17. A method of preparing an additive composition for papermaking, comprising:
preparing a cationic polyacrylamide (cPAM); and
selectively glyoxalating the cPAM to give a glyoxalated polyacrylamide (gPAM) resin, thereby preparing the additive composition;
wherein the cationic polyacrylamide (cPAM) is that of claim 1 and the glyoxalated polyacrylamide (gPAM) resin is that of claim 14.

18. A process of forming paper, said process comprising:
(1) providing an aqueous suspension of cellulosic fibers;
(2) combining an additive composition comprising a glyoxalated polyacrylamide (gPAM) resin prepared in-situ with the aqueous suspension, wherein the additive composition is that of claim 16;
(3) forming the cellulosic fibers into a sheet; and
(4) drying the sheet to produce a paper.

19. A polymer prepared via homopolymerization of N,N-dimethyl-N-2-acetamido-N-propylacryamide ammonium chloride (DMCA).

20. The polymer of claim 19, substantially free from acrylamide subunits.
